(19) United States
(12) Patent Application Publication
(10) Pub. No.: US 2003/0191729 A1
(43) Pub. Date: Oct. 9, 2003

(54) System for automating a web browser application

(76) Inventors: Chia Bin Siak, Singapore (SG); Teck Sin Lim, Singapore (SG)

Correspondence Address: DOWELL & DOWELL PC, SUITE 309, 1215 JEFFERSON DAVIS HIGHWAY, ARLINGTON, VA, 22202

(21) Appl. No.: 10/311,869

(22) PCT Filed: Jun. 22, 2001
(86) PCT No.: PCT/SG01/00129

(30) Foreign Application Priority Data
Jun. 22, 2000 (SG) 200003529-5

(51) Int. Cl. G06F 17/00; G06N 5/00

(52) U.S. Cl. 706/45

(57) ABSTRACT

A system for automating events performable on Internet information, such as a Web page requested, by a user using a Web browser, is disclosed. The automating system operates by receiving the requested Internet information for viewing on the browser, and modifying the requested Internet information, including tagging data therein upon which an event is dependable. An event includes the clicking of a hyperlink in the Web page. The automating system also operates by monitoring occurrence of the event using the tagged data, and performing knowledge acquisition when the user performs the event, wherein knowledge being acquired relates to logic by which the user performs the event.

### FIELD OF INVENTION

The present invention relates generally to computer programs or systems. In particular, the invention relates to automation of computer programs or systems for enabling activities to be performed on information accessible through a network, such information being abundantly found on such a network and constantly changing.

### BACKGROUND

Among the various Web browser applications or systems (browsers) that are commercially available, Microsoft Corporation's Internet Explorer and Netscape Communication Corporation's Netscape Communicator are more popular examples and Web pages from many Web sites have been designed for viewing on these browsers. Such browsers have also become a common platform upon which many users search for information, communicate with each other, perform transactions and the like browser-based activities.

Many of such activities performable on Web pages and other types of Internet information using browsers are repetitive in nature. For example, an individual may visit a particular Web site for retrieving and/or viewing Web pages containing information or images. The individual may later re-visit the Web site because the information or images constantly change and therefore wish to retrieve the latest information or images, by performing the same activities. Alternatively, the individual may have a set of values which are to be used as search keys on a Web site and such values have to be entered one-by-one for each search. In view of the repetitiveness of these activities, the retrieval of the latest information, images, or search results can become a time consuming affair.

As another example, many organizations may process large volumes of Internet information daily for reasons relating to business, research and development, or otherwise. While there may exist Web sites or the like service providers that offer services for processing and/or hosting the Internet information sought by these organizations, members of these organizations may still need to comb or “mine” numerous Web sites for any other relevant Internet information so as to ensure completeness. The processes of combing and mining Internet information may sometimes lead to expenditure of extensive effort, simply because of the vast amounts of Internet information made available.

In addition, these organizations may need to periodically monitor any updates of the Internet information consolidated by such means, which may include Internet information found or discovered by Internet search engines, posted on on-line portal Web sites and databases, and etc. The processes of updating and further consolidation of the Internet information may require of the organizations considerable effort and amounts of time because of the current situation of heavy network traffic on the Internet.

The inconveniences and problems caused by the repetitive and extensive natures of certain types of browser-based activities performable on Internet information may become more acute as the amount of Internet information grows. This is exacerbated by the Internet's network traffic situation.

The development of a system for automating most browser-based activities is hence desirable in view of the repetitive and extensive natures of these activities. A user may then rely on such a system for automation and thereby schedule processes for periodically performing or executing such activities.

There are several possible approaches for implementing such an automating system. However, there are substantial difficulties to overcome as regards implementation before any of these approaches can be considered generally suitable for use. One such difficulty is that many browsers, especially the various popular browsers, are considerably different in terms of user-interface features and support for services (e.g. Java Virtual Machine or JavaScript interpreter). These differences therefore necessitate building into any automating system sufficient robustness for working with the various popular browsers.

One approach for implementation proposes modification of any of the browsers for creating an automating system. This approach, however, is not feasible because there are a number of browsers that have been made available and considerable effort needs to be expended in order to understand and thereby modify each of these browsers. In addition, considerable effort is also required for keeping up with the latest versions of the browsers that have been commercially released so that the automating system also corresponds with the latest releases of browsers.

Another approach for implementation proposes the trapping of absolute Cartesian coordinates of user-generated events such as keyboard and mouse events that are initiated through use of the browsers for performing browser-based activities. The information derived by trapping the absolute Cartesian coordinates is then committed to memory or stored so that the information can be retrieved and used at a later time to automatically reinitiate the user-generated events for performing same activities. The information, however, is considered insufficient and unreliable because the browsers, namely those that are window-based, and the Internet information, such as Web pages, on which these activities are performable may be moved to different positions and changed in respect of contents or format, respectively. Thus the Cartesian coordinates are no longer representative of the user-generated events and therefore are no longer useful for automation purposes.

A further approach for implementation proposes the use of Microsoft Corporation's Network Query Language (NQL), which provides means for scripting user-generated events in relation to any browser-based activities performable on Internet information. The process of scripting in a computer system involves the creation of a set of instructions for performing or causing to perform any activities on the computer system or any information dealt with or handled by the computer system. However, it is believed that the scripts generated using NQL are strict or absolute in nature and are not adaptable to situational changes. Hence, the requirement of robustness is not met for an automating system based on NQL.

There is clearly a need for a system for automating browsers through which activities are performable on Web pages or the like information accessible via the Internet or the like network. Such an automating system preferably includes computer programming or system design based on high-level man-machine dialogue for acquisition of knowledge relating to such activities for building robustness into the automating system.

### SUMMARY

A system for automating browsers through which activities are performable on Web pages or the like information accessible via the Internet or the like network, is provided. Such an automating system preferably includes computer programming or system design based on high-level man-machine dialogue for acquisition of knowledge relating to such activities for building robustness into the automating system.

In accordance with a first aspect of the invention, a method for automating events performable on information requested by a user using a browser is provided. The method includes the steps of receiving the requested information for viewing on the browser, and modifying the requested information, including tagging data therein upon which an event is dependable. The method also includes the steps of monitoring occurrence of the event using the tagged data, and performing knowledge acquisition when the event is performed by the user, wherein knowledge being acquired relates to logic by which the user performs the event.

Preferably, the step of performing knowledge acquisition includes the step of interacting with the user in relation to the knowledge acquisition, wherein the step of interacting with the user includes the step of generating knowledge acquisition prompts, and wherein the step of generating knowledge acquisition prompts include the step of storing the knowledge acquisition prompts in a knowledge acquisition repository.

The method preferably further includes the step of generating a script for recording occurrence of the event and the logic, wherein the step of generating the script includes the step of storing the script in a script repository.

The method preferably further includes the step of generating a script for recording occurrence of the event and the logic, wherein the step of generating the script includes the step of generating a script having a variable dependable upon a value from a range of values. The method also further includes the step of storing the range of values in a data source from which the value is extractable.

The method preferably further includes the step of generating a script for recording occurrence of the event and the logic, and further includes the step of executing the script leading to re-occurrence of the event.

Preferably, the method further includes the step of downloading further information dependent on occurrence of the event, wherein the step of downloading further information includes the step of drilling for further information, and wherein the step of drilling for further information includes the step of vertically drilling for further information.

Preferably, the method further includes the step of downloading further information dependent on occurrence of the event, wherein the step of downloading further information further includes the step of storing the further information in an information repository.

In accordance with a second aspect of the invention, a system for automating events performable on information requested by a user using a browser is provided. The system includes means for receiving the requested information for viewing on the browser, and means for modifying the requested information, including means for tagging data therein upon which an event is dependable. The system also includes means for monitoring occurrence of the event using the tagged data, and means for performing knowledge acquisition when the event is performed by the user, wherein knowledge being acquired relates to logic by which the user performs the event.

Preferably, means for performing knowledge acquisition includes means for interacting with the user in relation to the knowledge acquisition, wherein means for interacting with the user includes means for generating knowledge acquisition prompts, and wherein means for generating knowledge acquisition prompts include means for storing the knowledge acquisition prompts in a knowledge acquisition repository.

The system preferably further includes means for generating a script for recording occurrence of the event and the logic, wherein means for generating the script includes means for storing the script in a script repository.

The system preferably further includes means for generating a script for recording occurrence of the event and the logic, wherein means for generating the script includes means for generating a script having a variable dependable upon a value from a range of values. The method also further includes means for storing the range of values in a data source from which the value is extractable.

The system preferably further includes means for generating a script for recording occurrence of the event and the logic and further includes means for executing the script leading to re-occurrence of the event.

Preferably, the system further includes means for downloading further information dependent on occurrence of the event, means for downloading further information includes means for drilling for further information, and means for drilling for further information includes means for vertically drilling for further information.

Preferably, the system further includes means for downloading further information dependent on occurrence of the event, means for downloading further information further includes means for storing the further information in an information repository.

In accordance with a third aspect of the invention, a computer program product, including a computer usable medium having computer readable program code means embodied in the medium for automating events performable on information requested by a user using a browser is provided. The computer program product has computer readable program code means for receiving the requested information for viewing on the browser, and computer readable program code means for modifying the requested information, including tagging data therein upon which an event is dependable. The computer program product also has computer readable program code means for monitoring occurrence of the event using the tagged data, and computer readable program code means for performing knowledge acquisition when the event is performed by the user, wherein knowledge being acquired relates to logic by which the user performs the event.

Preferably, the computer readable program code means for performing knowledge acquisition includes computer readable program code means for interacting with the user in relation to the knowledge acquisition, wherein the computer readable program code means for interacting with the user includes computer readable program code means for generating knowledge acquisition prompts, and wherein the computer readable program code means for generating knowledge acquisition prompts include computer readable program code means for storing the knowledge acquisition prompts in a knowledge acquisition repository.

The product preferably further includes computer readable program code means for generating a script for recording occurrence of the event and the logic, wherein the computer readable program code means for generating the script includes computer readable program code means for storing the script in a script repository.

The product preferably further includes computer readable program code means for generating a script for recording occurrence of the event and the logic, wherein the computer readable program code means for generating the script includes computer readable program code means for generating a script having a variable dependable upon a value from a range of values. The product also further includes computer readable program code means for storing the range of values in a data source from which the value is extractable.

The product preferably further includes computer readable program code means for generating a script for recording occurrence of the event and the logic, and further includes computer readable program code means for executing the script leading to reoccurrence of the event.

Preferably, the product further includes computer readable program code means for downloading further information dependent on occurrence of the event, wherein the computer readable program code means for downloading further information includes computer readable program code means for drilling for further information, and wherein the computer readable program code means for drilling for further information includes computer readable program code means for vertically drilling for further information.

Preferably, the product further includes computer readable program code means for downloading further information dependent on occurrence of the event, wherein the computer readable program code means for downloading further information further includes computer readable program code means for storing the further information in an information repository.

### BRIEF DESCRIPTION OF DRAWINGS

Embodiments of the invention are described hereinafter with reference to the drawings, in which:

FIG. 1 is a screen shot of a toolbar provided by an automating system according to an embodiment of the invention for manipulating macros that run on top of a Web browser;

FIG. 2 is flow diagram for illustrating a process for deploying by a user the automating system of FIG. 1 for automating various Web based activities;

FIG. 3 is a screen shot of a “logic” graphical user interface (GUI) provided by the automating system of FIG. 1 for determining the user's logic for selecting a hyperlink;

FIG. 4 is a screen shot of an “image” GUI provided by the automating system of FIG. 1 for determining the user's logic for selecting an image;

FIG. 5 is a screen shot of a “form” GUI provided by the automating system of FIG. 1 for determining the user's logic for filling in a hypertext markup language (HTML) form;

FIG. 6 is a screen shot of a “page collection” GUI provided by the automating system of FIG. 1 through which the user enter parameters for vertical drilling in relation to downloading of Internet information;

FIGS. 7 and 8 are screen shots of a set of page collection GUIs provided by the automating system of FIG. 1 through which the user enter parameters for horizontal drilling in relation to downloading of Internet information;

FIG. 9 is a screen shot of a “macro” GUI provided by the automating system of FIG. 1 through which the user enters and confirms details of a macro scripted by the automating system in relation to the activities performed by the user;

FIGS. 10, 11 and 12 are screen shots of a set of “playback” GUIs provided by the automating system of FIG. 1 through which the user may invoke through the automating system repeat previously performed activities;

FIG. 13 illustrates a networked or distributed implementation of an automating system according to an embodiment of the invention;

FIG. 14 illustrates the architecture of a “Proxy” system in the automating system of FIG. 13;

FIG. 15 is a flowchart of processes in a Recording Session;

FIG. 16 is a flowchart of steps in a Record Initialization process;

FIG. 17 is a flowchart of steps in a Record PR Collection process;

FIG. 18 is an example of a portion of a Remote Page sent by a Remote Site to a Proxy system;

FIG. 19 is an example of a portion of a Modified Web Page after processing by the Proxy system;

FIG. 20 is a flowchart of steps in a Record ECI Generation process;

FIG. 21 is a flowchart of steps in a Record Knowledge Acquisition process;

FIG. 22 is a block diagram illustrating the role of a MetaKnowledge Repository in the knowledge acquisition and Process Knowledge harvesting processes;

FIG. 23 is a flowchart of sub-processes in a Download Contents process;

FIG. 24 is a flowchart of steps in a Download Initialization sub-process;

FIG. 25 is a flowchart of steps in a Download Drill sub-process;

FIG. 26 is a flowchart of steps in a Download Fetch Page sub-sub-process in the Download Drill sub-process in FIG. 25;

FIG. 27 is a flowchart of steps in a Download Report sub-process;

FIG. 28 is a flowchart of processes in a Playback Session;

FIG. 29 is a flowchart of steps in a Playback Initialization process;

FIG. 30 is a flowchart of steps in a Playback RP Collection process;

FIG. 31 is a flowchart of steps in a Scripts Maintenance process;

FIG. 32 is a flowchart of steps in a Create MultiScript process;

FIG. 33 is a flowchart of steps in a Run MultiScript process; and

FIG. 34 illustrates the components of a general-purpose computer by which the automating system may be implemented.

### DETAILED DESCRIPTION

A system according to an embodiment of the invention for automating browsers through which browser-based activities are performable on Web pages or the like Internet information accessible via the Internet or the like network, is described hereinafter. Such an automating system preferably involves system design based on high-level man-machine dialogues for acquisition of knowledge relating to such activities for building robustness into the automating system.

The automating system initially gathers knowledge from users of browsers while the users perform activities for carrying out functions on or run processes with Internet information retrieved or downloaded using the browsers. The automating system then relies on such gathered user knowledge for controlling and executing the same activities for any repetitions of such functions or processes. In this way, the deliverables on the repeated functions or processes are more robust as the deliverables are not dependent on the underlying technologies implemented by various Web sites or the like resources that are providing the Internet information.

In attempting to meet the need for an automating system for addressing at least one of various problems associated with conventional automating systems, the automating system according to an embodiment of the invention is provided with a number of features or capabilities. Firstly, the automating system is capable of facilitating the robust automation of activities that are repetitively performable on Internet information using browsers.

Additionally, the automating system is capable of facilitating the acquisition of user knowledge in relation to the performance of activities so that the automating system generates computer programs or scripts that control and execute the same activities for repetition of the intended functions or processes in a robust manner. The automating system does so by providing GUIs which present a set of queries relevant to the activities initially performed by the user so as to facilitate the capture of intentions of the user for subsequent repetitive control and execution.

Also, the automating system includes a repository from which a set of queries and GUIs are generated. The inclusion of such a repository allows the input of domain related queries that not only facilitates the capturing of user intentions, but also acquires implicit and explicit knowledge that an organization may wish to trap from user.

Furthermore, the automating system is capable of facilitating interactivity between the user and the automating system so that the automating system generates scripts that are robust in nature for handling dynamic situations.

Yet furthermore, the automating system is capable of facilitating control and execution of scripts generated by the automating system for repetitively or periodically performing downloading, searching, communication, information monitoring, and the like activities.

In addition, the automating system is capable of interfacing parts of the scripts which are known as variables with data sources such as databases or ASCII data files. This allows the automating system to repetitively execute the scripts with values pulled from such data sources.

Features or Capabilities of the Automating System

To provide at least one of such features or capabilities, the simplest implementation of the automating system preferably includes a computer having a processor, a display, a device providing storage, user-input devices, and a network communications device for connecting the computer to the Internet or the like network, and a computer program for automation which is capable of being executed on the computer, both the computer and the automation program being integral components of the automating system. The automation program essentially contains instructions which when carried out by the processor enables the processor to control and direct the computer to provide at least one of the features or capabilities.

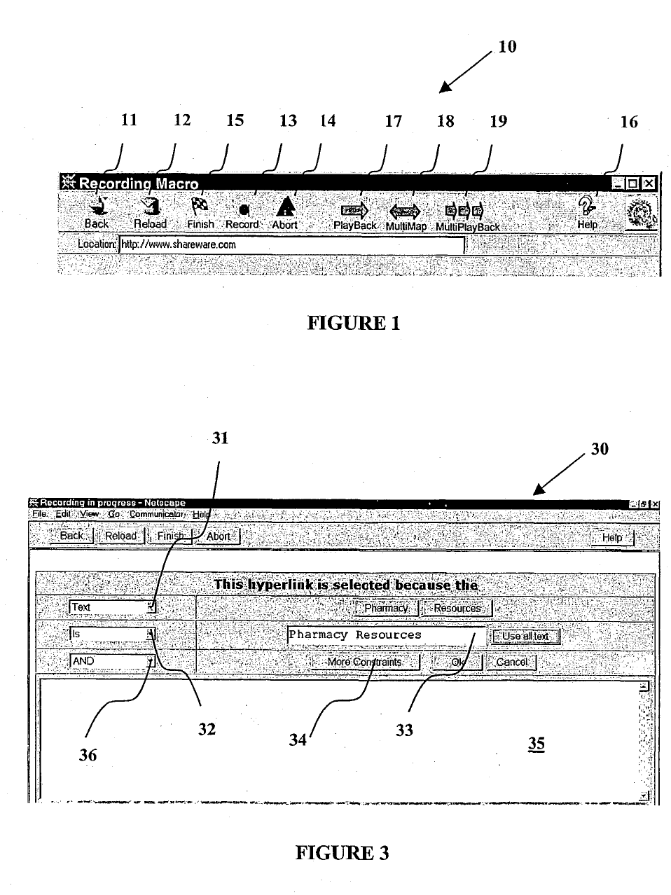

Preferably, the automating system starts up when a user by means of a browser accesses a Web site that hosts the automation program. At that instant, the automation program is downloaded from the Web site and is subsequently executed on the computer. The automating system next hides the toolbar provided by the browser and displays a toolbar 10 shown in FIG. 1. Alternatively, the automation program may be locally stored in the storage device on the computer and starts up when the user clicks on any indicia, for example a “shortcut” for the automation program, displayed on the computer for invoking the automation program.

The toolbar 10 shown in FIG. 1 provides indicia for the user to, among others: go back ti a previously loaded Web page (11); refresh the currently loaded Web page (12); commence recording and generation of a macro (13); stop and abort a recording session which is in progress (14); finish and save a recording session which is completed (15); obtain help and comments on various functionalities and GUIs provided by the toolbar (16); and playback the generated macro (17).

Overview

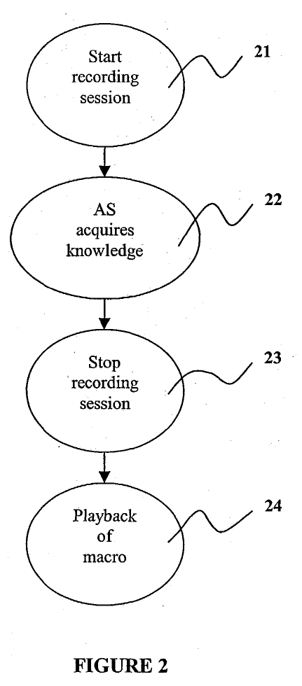

A brief overview of the operation of the automating system is described with reference to FIG. 2, which is a flow diagram for illustrating how the user may deploy the automating system for automating various browser-based activities.

To use the automating system, the user first types a target universal resource indicator (URI) and starts the recording session on this URI by clicking on the “Record” button 13 on the toolbar 10 in an operational step 21. The automating system next in an operational step 22 interactively determines the user's rationale or logic for performing certain activities such as events or actions. This knowledge is consolidated as a macro and is saved when the user stop the recording session by clicking the “Finish” button 15 on the toolbar 10 in an operational step 23. A process of downloading Internet information, if necessary, also occurs. The user may then playback the same macro in an operational step 24 subsequently for repeating such browser-based activities by clicking on the “Playback” button 17 on the toolbar 10.

Recording Session

After the recording session starts up in the operational step 21 and during the recording session of the operational step 22, the automating system dynamically generates GUIs for ascertaining the rationale or logic behind certain activities known as events or actions performed by the user using the browser. This GUI generation process is event-driven, and different events lead to the automating system presenting different GUIs to the user. The repository from which the set of queries and GUIs are generated is called by the automating system during the GUI generation process.

Selection of Hyperlink/Image

When a textual-hyperlink on a Web page on which the user is working is selected, the automating system presents a “logic” GUI 30 as shown in FIG. 3 to the user for acquiring or capturing the rationale or logic involved in the selection of the hyperlink. The user may choose the hyperlink for a variety of reasons. For example, the text of the hyperlink may contain related important words or combination of letters, such as “Vol”, “Current Issue”, etc. Alternatively, the hyperlink may relate to a number that satisfies certain conditions such as a cutoff or threshold value. It is also possible that the hyperlink is chosen because the hyperlink bears the current or latest date of the Web page to which the hyperlink is linked.

To help the user formulate the rationale or logic, the automating system through the logic GUI 30 provides the user with a list of hyperlink descriptives via a drop-down menu 31 which provides a list of words from which the user may select that is descriptive of the hyperlink text. The GUI 30 also provides the user with a list of keywords such as “contain”, “is”, “greater than”, “greatest”, or “offset by” from which the user may select using drop-down menu 32. These keywords allow the user to specify the relationship between the hyperlink and any text(s) or value(s) (such as a numeric cutoff or threshold) forming the basis of the selection criteria of the hyperlink. An entry box 33 is provided to allow the user to type/key in or select from a number of buttons 33A and 33B the text(s) or value(s) involved in the formulation of the logic. The buttons 33A and 33B have text representations thereon which are derived from the hyperlink text, the text representation on each of the buttons 33A and 33B being a component of the hyperlink text. The automating system by providing a series of buttons in the GUI 30 such as buttons 33A and 33B therefore provides an interactive means of rationale or logic formulation by the user.

The automating system also allows the user to set more than a single selection criteria by providing a “More Constraints” button 34 on the logic GUI 30. When this button is clicked, a window area 35 becomes active so that the user may enter any additional selection criteria. The window area 35 is accompanied by a logical operator list, for example AND, OR, and NOT operators, from which the user may select using a dropdown menu 36 for logically linking the first selection criteria to the subsequent selection criteria.

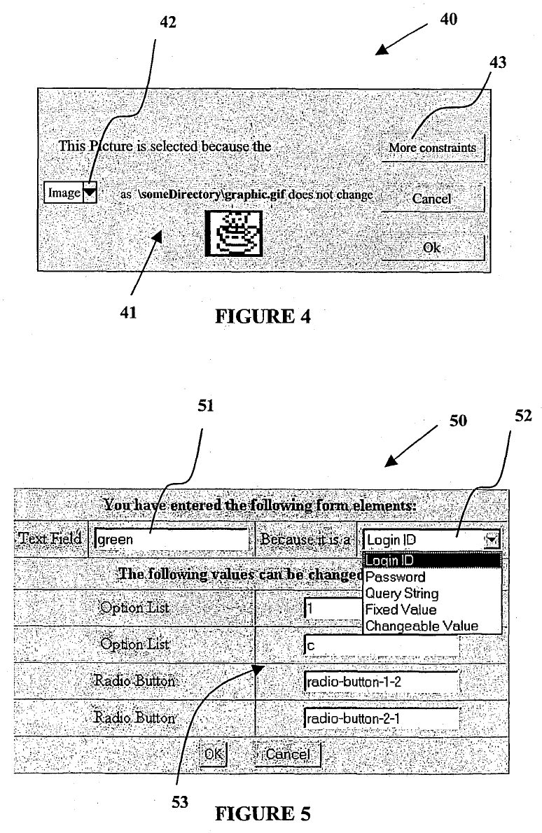

When an image on a Web page on which the user is working is selected either by the user clicking on the image- or textual-hyperlink providing a link to the source of the image, the automating system presents an “image” GUI 40 shown in FIG. 4. The URI related to the hyperlink is visually presented to the user for confirmation via indicia 41 before the automating system scripts such an event or action into the macro. The rationale or logic is also captured by the automating system using the image GUI 40 in which the user formulates the rationale or logic using a drop-down menu 42 to select a word describing the image, and a “More Constraints” button 43. The “More Constraints” button 43 when clicked on renders active a window area (not shown) for the user to enter a selection criteria in addition to or to modify a default selection criteria shown in the indicia 41.

Other parameters for representing the image such as “alternative text”, which is the textual information accompanying and representing an image in a Web page, may also be included in the indicia 41 and therefore included in the formulation of the rationale or logic.

Events Related to Forms

When the user submits information such as a keyword, a login name, or a password by clicking a “Login” or “Submit” button on an HTML form as part of or accompanying a Web page on which the user is working, the automating system generates and presents a “form” GUI 50 as shown in FIG. 5 to the user. The form GUI 50 enables the user to verify the data entered in the HTML form and provide the reasons for doing so. The automating system through the form GUI 50 allows the user to provide keyword(s) which form(s) the basis of a submission by including a “Text Field” box 51 for the user to enter the relevant keyword(s). The GUI 50 also includes a drop-down menu 52 from which the user chooses the relevant type of event that is occurring. The types of events that may occur in relation to an HTML form include: a “Login” event where the user enters a string of text as identification (ID) for login purposes; a “Password” event where the user enters an encrypted string as a password; a “Query String” event where the user enters a string as a query for searching and the like purposes; a “Fixed Value” event where the user enters a string that may not change; and a “Changeable Value” event where the user enters a string that may change. Other parameters typically found in an HTML form for enabling a login or submission session such as option lists and “Radio” buttons can be entered in relevant text boxes 53.

Automating the Downloading of Documents

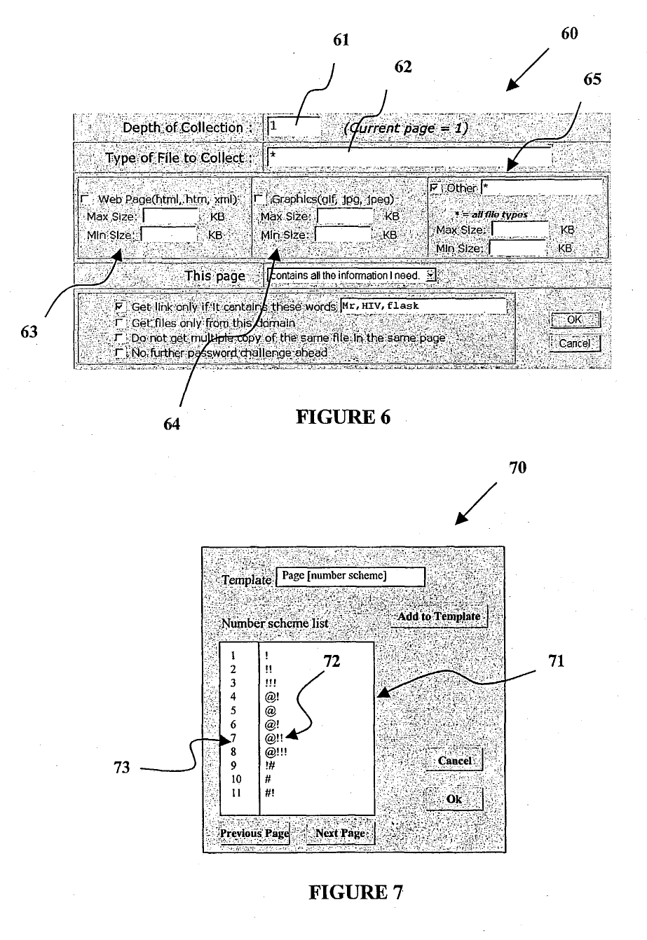

When the user clicks the ‘Finish’ button 15 on the toolbar 10 of FIG. 1 in the operational step 23 of FIG. 2 to indicate the completion of the scripting of the user's actions performed via the underlying browser, the automating system next proceeds with carrying out the process of downloading Internet information by presenting a set of “page collection” GUIs (60, 70, and 80 shown in FIGS. 6, 7 and 8, respectively) to the user. The automating system through these GUIs queries the user about ways to filter the contents to be downloaded and the downloading approaches. There are two ways in which downloading of Internet information can be performed: vertical drilling and horizontal drilling.

Vertical Drilling

Each Web page typically contains a set of textual- and/or image-hyperlinks. Each hyperlink has two components, the address or URI of the object to which the hyperlink links or points, for example an image or another HTML document, and the name of the hyperlink, for example the text on which the user clicks. Each hyperlink may thus link the current Web page to another Web page that in turn contains another set of hyperlinks. This hierarchical nesting of hyperlinks may recur “vertically” for many levels. However, the user may wish to vertically collect or “drill” for Internet information only to a certain level. The parameters that are typically considered in vertical drilling include depth of collection and content filtering.

In relation to the depth of collection, the automating system through the page collection GUI 60 shown in FIG. 6 provides means for the user to indicate numerically the depth of collection using a text box 61. If the user wishes to only download contents of the current Web page, the user may do so by setting the depth of collection to ‘1’ using the text box 61. Otherwise, the user may specify a depth for the automating system to drill vertically downwards in the process to collect all the related hyperlinks.

In relation to content filtering, the automating system through the page collection GUI 60 provides means for the user to define the type of Internet information for collection using a text box 62. The automating system also provides the user with other means to further describe the content of Internet information for collection so that the user may control the types of files that are to be downloaded. For example, whether the Internet information relates to Web pages or graphics information, text boxes 63 and 64, respectively, for defining the type and size of such information are provided on the page collection GUI 60. If the Internet information does not relate to either Web pages or graphics information, the user may use text boxes 65 to define such information using information relating to file types and sizes.

Horizontal Drilling

There are Web sites, for example those Web sites that host search engines, which provide large quantities of Internet information upon requests made by the user and such information are paginated into a number of Web pages for ease of browsing by the user. The user due to the large amount of Internet information therefore needs to perform certain actions such as clicking a “Next” button or a hyperlink having a page number on the currently browsed Web page in order to retrieve the corresponding paginated Internet information. This process of retrieving paginated Internet information is also described as horizontal drilling. The automating system thus provides the page collection GUIs 70 and 80 in FIGS. 7 and 8, respectively, for enabling the user to perform or carry out Horizontal Drill Events (HDE). Such events include the clicking of a hyperlink that has a particular image, or the clicking of a hyperlink that has a numeric hyperlink name that increments according to certain step(s) and in a consecutive fashion, for example ‘1’, ‘2’, ‘3’, etc. The events may also include the clicking of a hyperlink that has an alphanumeric profile, for example ‘Page 1’, ‘Page 2’, etc. The user may also specify the pagination scheme if such a scheme is not conventional, by entering into a window area 71 a set of symbols 72 corresponding to the logical page numbers 73 using the GUI 70 as shown in FIG. 7. The user may provide further details regarding the horizontal drilling via the GUI 80 as shown in FIG. 8 by firstly allowing the user to select from a drop-down menu 81 an objective for performing the horizontal drilling. The user may further qualify the objective by selecting from an option list 82 a qualification to the objective set out using drop-down menu 81. The relationship between the current page and the subsequent pages that are to be accessed are also described using a list selectable via a drop-down menu 83.

Completion of Recording

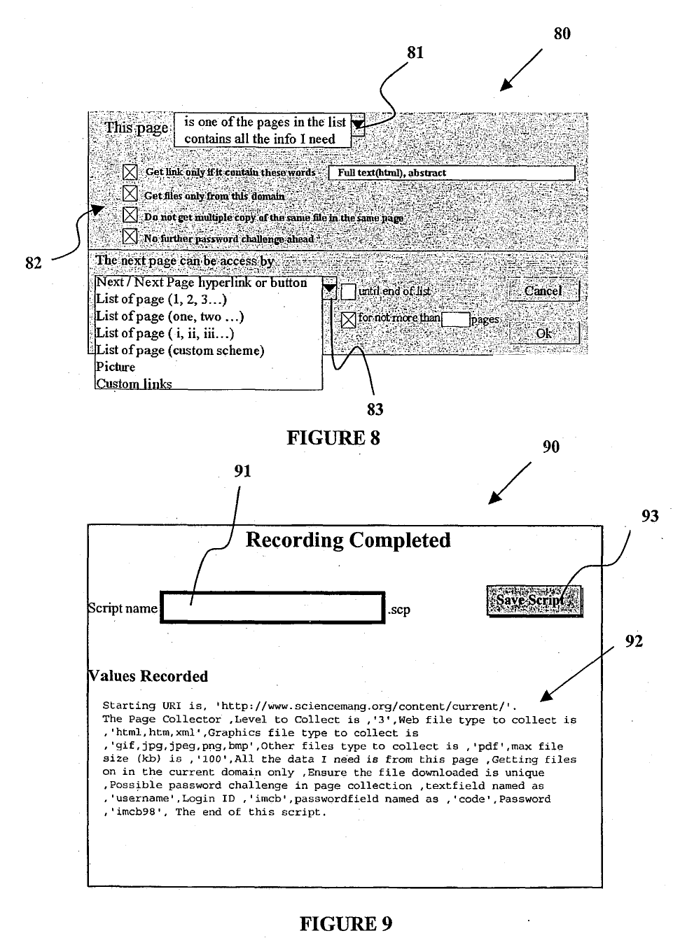

When the downloading process is completed, whether by way of vertical drilling and/or horizontal drilling, the automating system next in the operational step 23 of FIG. 2 generates and displays a “macro” GUI 90 as shown in FIG. 9 for the user to enter or provide details relating to the macro scripted by the automating system in relation to all the activities the user has performed. The macro is saved after the user enters in a text box 91 a file name under which the macro is to be saved, reads and confirms a summary (92) of the contents of the macro, and clicks a “Save” button 93.

Playback Session

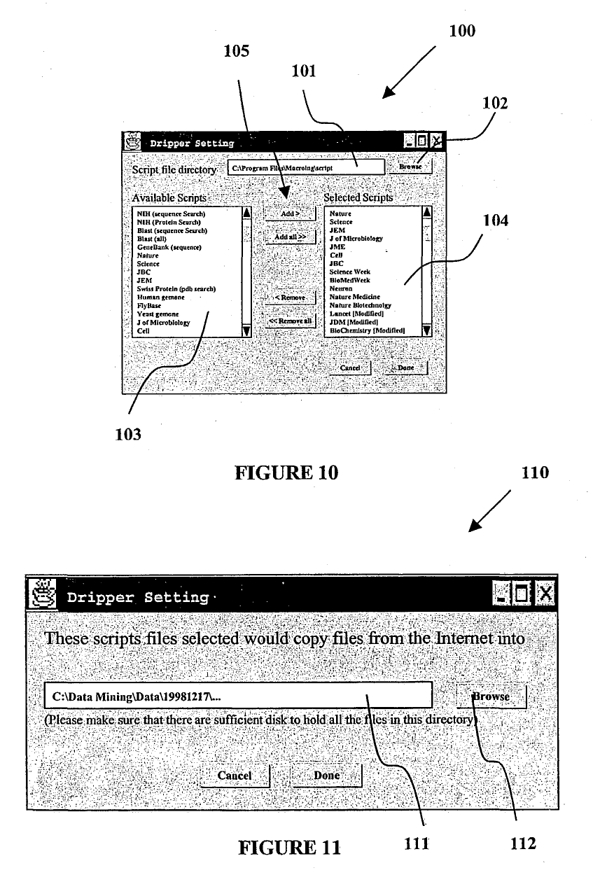

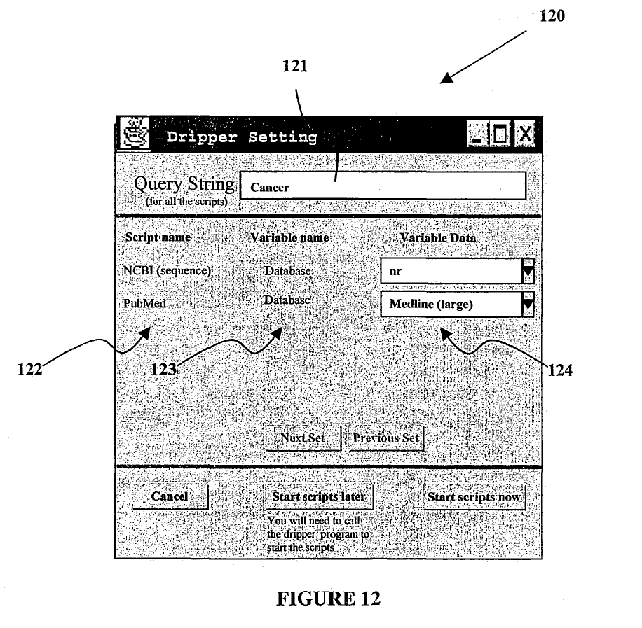

Once the macro is saved, the user may execute the same macro at any later point in time by first clicking the Playback button 17 on the toolbar 10 in the operational step 24 of FIG. 2. This action allows the user to initiate an automated repetition of the same activities previously recorded by the automating system by using a set of “playback” GUIs 100, 110 and 120, shown in FIGS. 10, 11 and 12, respectively, provided by the automating system. To execute the macro and repeat the activities, the user using the playback GUI 100 is required to enter in a text box 101 or select from a drop-down menu 102 the directory on which the macro is stored. The user is also required to select from a list of available macros (103) a list of macros (104) the user intends to execute. A group of buttons 105 is also provided to help facilitate the selection or removal of scripts or macros.

After the user provides or enters the relevant information for initiating the execution of the macros, the user is next required, using the playback GUI 110, to enter in a text box 110 or select through a “Browse” button 112 an output directory on which the automating system in repeating the same activities is to store the downloaded Internet information.

The user may also wish to modify an existing macro before executing the macro. To facilitate this, the automating system provides in the playback GUI 120 a “Find-and-Replace” function for user to replace values of various activities or events that are to be captured. For example, if user previously entered “xxx” as a query string as part of a previously performed activity, the user may replace the string “xxx” with the word “Cancer” by selecting an event “QueryString” from the playback GUI 120. The word “Cancer” is entered into a text box 121 by the user for the replacement to take effect. All executions of macros (122) containing the query string “xxx” consequently have such query strings replaced by the query string “Cancer”, and therefore such executions based on the replacement query string. Additionally, the query string may have variable(s) associated therewith and such variable(s) and corresponding data are indicated in the playback GUI 120. Therefore, script name(s) (122) of relevant macro(s) are indicated on the playback GUI 120 together with variable name(s) (123) and variable data (124) for the user to confirm.

Additionally, the user may also wish to execute macros using a variable for a particular range of values or text defined in the macro, such a range being stored in a variable data source, for example a database or an ASCII data file. Results obtained from the execution of such a macro are therefore subjected to the range of the variable stored in the variable data source.

Architecture of the Automating System

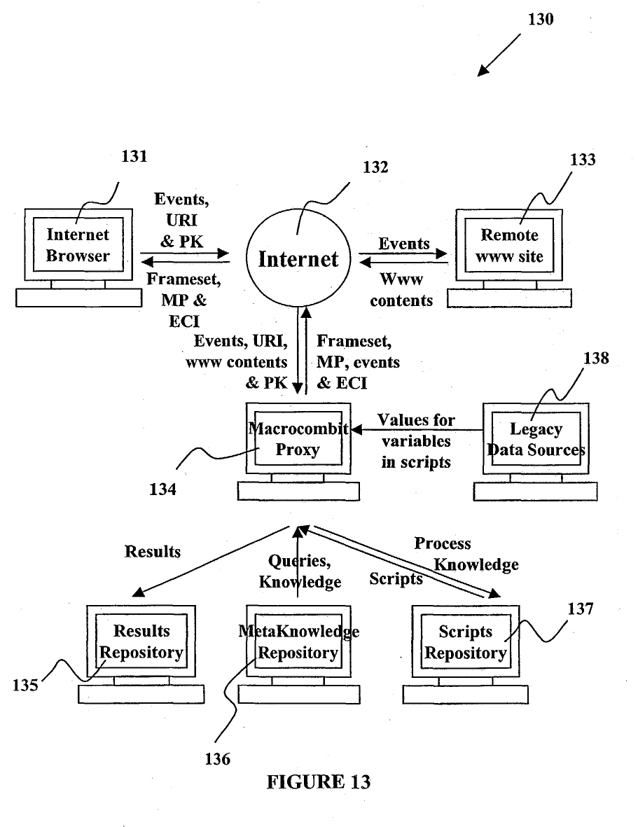

The implementation of the automating system is described hereinafter with reference to FIGS. 13 to 33. The automating system is preferably implemented within the context of a networked computing environment. Such an implementation allows the automating system to harness and leverage the many advantages of shared, distributed, or specialized processing. Moreover, multiple users may benefit from the automating system implemented in such a manner because of the existence of common or shared resources that the multiple users may at the same time access. The features or capabilities provided by such an implementation of the automating system are preferably similar to those described in relation to the forgoing automating system of simpler implementation, and therefore are also made available to the multiple users.

The automating system 130 being implemented in such a manner, as shown in FIG. 13, is a system that preferably involves the Internet 132, a network of computing systems 131 and 133 to 138, each computing system preferably having processing units, computer memory, storage devices, and display devices. To use the automating system, a user first invokes a Web or Internet Browser (IB) which is executed on an IB computer 131 and interacts with a “Proxy” (McPx) system, which is hosted by or executed on a McPx computer 134. This interaction relates to the recording session and the purpose for such an interaction is for acquiring “Process Knowledge” (PK), which is knowledge in relation to the user's rationale or logic for wishing to communicate with and perform activities including events and actions on Internet information from a “Remote Site” (RS) 133. The Remote Site 133 may refer to a Web site and any other Web sites related by hyperlinks, and the like Web resources. To facilitate such knowledge acquisition, the Proxy system provides “Event Capturing Interfaces” (ECI) to the IB computer 131 for facilitating the acquisition or collection of Process Knowledge systematically.

The Event Capturing Interfaces refer to the foregoing logic, image, and form GUIs 30, 40 and 50. The set of events or actions performed or generated by the user, the URI of the Remote Site 133 accessed, and Process Knowledge involved are captured as the user creates macros or scripts which can be saved in computer memory or onto a storage medium such as a “Script Repository” 137. This is to allow the events to be repeated or re-executed as and when required by the Proxy system during the playback session. A “MetaKnowledge Repository” 136 is available for controlling and directing the knowledge acquisition and PK harvesting processes. The MetaKnowledge Repository 136 essentially generates the set of queries and GUIs which the Proxy System utilizes. The results obtained from carrying out the events or actions may be viewed by the user as “Modified Pages” (MP) or set of Modified Pages (“Frameset”) on the display of the IB computer 131. Alternatively, the Internet information may also be saved onto a storage medium such as a “Results Repository” 135 for future retrieval.

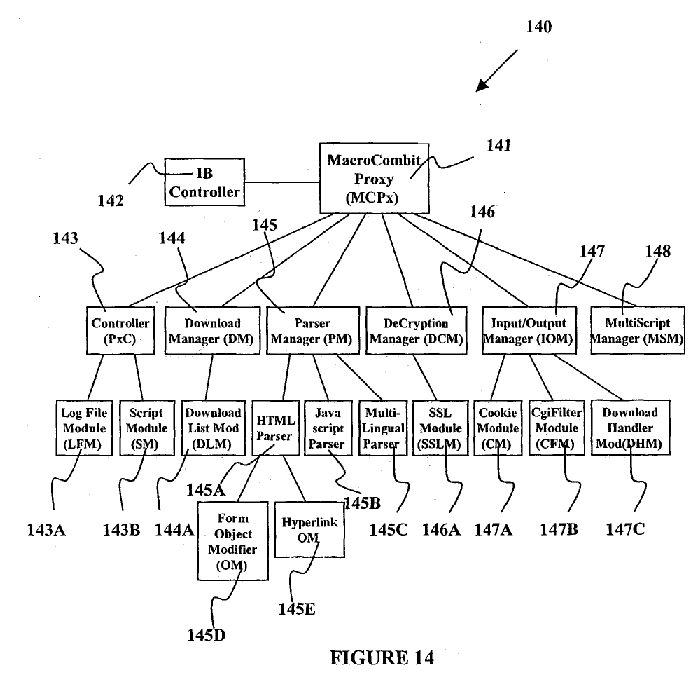

The generation and execution of scripts are performed by the Proxy system. The Proxy system, as shown in FIG. 14 and hereinafter generally assigned the reference numeral 141, includes a number of modules, namely: an “IB Controller” 142; a “Controller” 143; a “Download Manager” 144; a “Parser Manager” 145; a “Decryption Manager” 146; and an “I/O Manager” 147; and a “MultiScript Manager” 148.

The function of the IB Controller 142 is to set up, start up and control the Internet Browser that executes on the IB computer 131.

The Controller 143 directs the flow of information among all the modules. The Controller 143 includes and directly controls a “Log File Module” 143A which stores all interactions onto a storage medium. The Controller also includes a “Script Module” 143B which stores all the scripts generated for playback or modification purposes.

The Download Manager 144 manages the downloading process of the Proxy system 141, and includes a “Download List Module” 144A. The Download List Module 144A extracts URIs and maintains a “to-do” list for the Download Manager 144. The module also generates Frameset(s) and ensures that the to-do activities in the list are carried out.

The Parser Manager 145 breaks or fragments a Web page into objects and tags the objects so as to facilitate the knowledge acquisition process. The Parser Manager 145 includes a “HTML Parser Module” 145A having a set of modifiers that tag objects such as forms or hyperlinks for facilitating the knowledge acquisition process. The modifiers include a “Form Object Modifier” 145D that tags objects that may be found on a Web form and a “Hyperlink Object Modifier” 145E that tags hyperlinks that may be found on a Web page. In addition to the HTML Parser Module 145A, the Parser Manager 145 also includes a parser for processing JavaScript objects (145B), and a parser for processing Web pages in Chinese or other languages (145C).

The Decryption Manager 146 encrypts and decrypts Web pages that are to be sent and received by the Proxy system 141. The Decryption Manager 146 includes various sub-modules for handling different security protocols. For example, a “Secure Socket Layer (SSL) Module” 146A is implemented for allow recording and playback of scripts using the SSL protocol.

The I/O Manager 147 receives and sends instructions and contents for the Proxy system 141 between the Internet Browser on the IB computer 131 and the Remote Site 133. During the recording phase, the I/O Manager 147 deploys sub-modules for performing modification of outgoing URIs using a “Cookie Module” 147A and a “CGI Filter Module” 147B, extraction of Process Knowledge using the Cookie module 147A and the CGI Filter module 147B, and various steps of the downloading process using a “Download Handler Module” 147C.

The MultiScript Manager 148 facilitates the execution of multiple scripts and instantiates variables of these multiple scripts with values from a legacy data source.

Details for Implementation of the Automating System

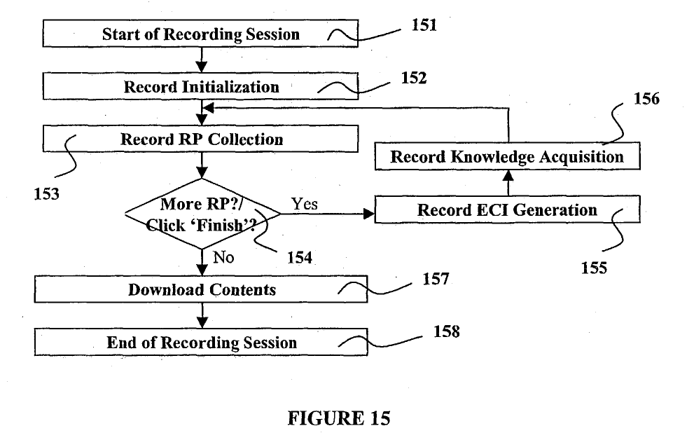

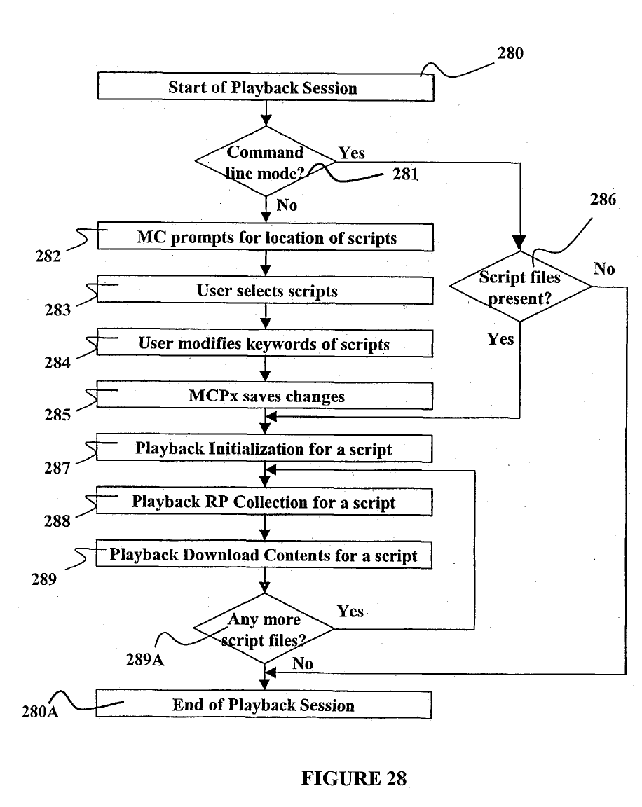

A description of processes that occur within the automating system when the user uses the automating system to generate scripts via a Recording Session in relation to the operational steps 21 to 23 of FIG. 2, as illustrated in FIGS. 15 to 27, and to execute scripts via a Playback Session in relation to the operational steps 24 of FIG. 2, as illustrated in FIGS. 28 to 30, is provided.

Recording Session

With reference to FIG. 15, the Record Session includes the following processes: a “Record Initialization” process 152; a “Record Remote Page (RP) Collection” process 153; a “Record ECI Collection Generation” process 155; a “Record Knowledge Acquisition” process 156; and a “Download Contents” process 157.

In the Record Initialization process 152, the user starts up the Proxy system, which in turn sets up the Internet Browser and determines which Remote Site 133 the user wishes to access. Next in the Record RP Collection process 153, the Proxy system retrieves or collects a Remote Page from the Remote Site 133. The user then generates an event on the retrieved Remote Page by, for example, clicking on a hyperlink. The Proxy system then carries out the Record ECI Generation process 155, the Record Knowledge Acquisition process 156, and then the Record RP Collection process 153 again if the user wishes to retrieve another Remote Page from the Remote Site 133. The looping of the processes repeats until the user clicks on the ‘Finish’ button 15 that is found on the toolbar 10, both being shown in FIG. 1, in process 154.

In the Record ECI Generation process 155, the Proxy system creates and displays an Event Capture Interface on the display of the 131 computer 131 for posing and presenting questions to the user for gathering Process Knowledge. In the Record Knowledge Acquisition process 156, the Proxy system harvests Process Knowledge that is collected via the Event Capture Interface. In the Download Contents process 157, the Proxy system retrieves contents from the final or latest Web page that the user accessed.

Record Initialization

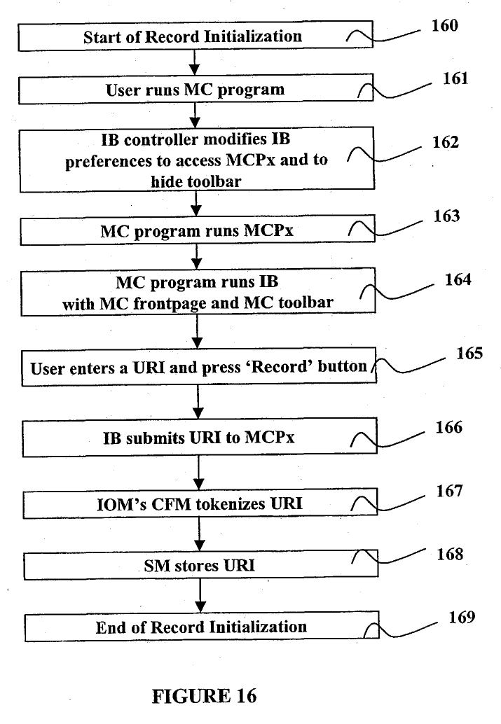

With reference to FIG. 16, the Record Initialization process 152 is described. The user first activates the automation program which when executed on the IB computer 131 forms a system which provides interaction and access between the user and the automating system, such a system hereinafter generally being referred as an MC system, which in turn invokes the IB controller 142 in a step 161. The IB controller 142 next in a step 162 modifies the settings of the Internet Browser such that the Internet Browser accesses the Proxy system instead of a default proxy set in the Internet Browser.

The MC system also checks if the Proxy system is active, and invokes the Proxy system if otherwise, in a step 163. The MC system also checks if the Internet Browser is active and also invokes the Internet Browser if otherwise. The Internet Browser is also set to display a Web page containing information regarding the MC system, and the toolbar 10 in a step 164.

The user next in a step 165 enters a URI and presses the Record button 13 on the toolbar 10. The Internet Browser sends the URI to the Proxy system in a step 166. Upon receipt of the URI, the Proxy system tokenizes and stores the URI via the CGI Filter Module 147B in a step 167 and the Script Module 143B in a step 168, respectively.

Record RP Collection

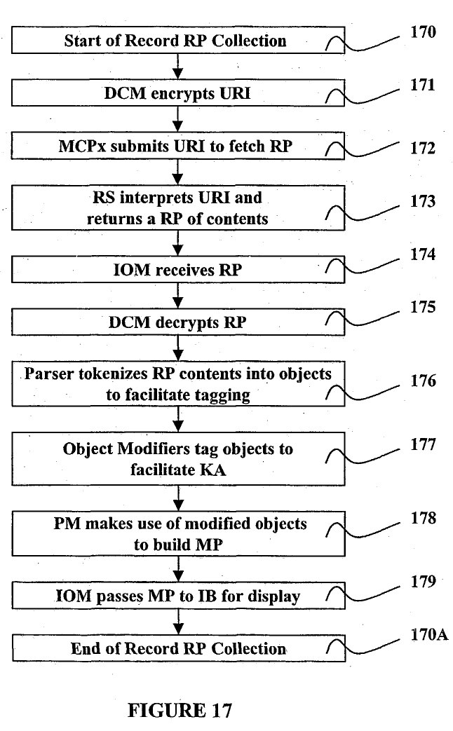

The Record RP Collection process 153 is described with reference to FIG. 17. Upon receiving the URI, the Proxy system may encrypt the URI in a step 171. Encryption is only necessary when the Proxy system is communicating with is the Remote Site via the Internet 132. Information sent between the Proxy system and the Internet Browser does not need to be encrypted if the interactions are within an Intranet environment.

The Proxy system in a next step 172 sends the encrypted URI to the Remote Site 133 for fetching the Remote Page.

The Remote Site 133 then interprets the URI and returns a Remote Page to the Proxy system accordingly in a step 173. The Proxy system receives the Remote Page via the I/O Manager 147 in a step 174 and decrypts the Remote Page via the Decryption Manager 146 in a step 175. The Proxy system then breaks the Remote Page into objects via the Parser Manager 145 in a step 176. The objects are tagged by the Form Object Modifier 145D or the Hyperlink Object Modifier 145E accordingly in a step 177. The modified objects are subsequently pieced together into a Modified Web Page (MP) by the Parser Manager 145 in a step 178. The Modified Web Page is then delivered to the Internet Browser for display on the IB computer 131 in a step 179A.

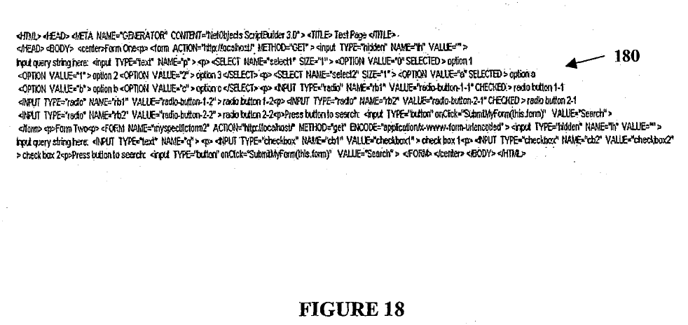

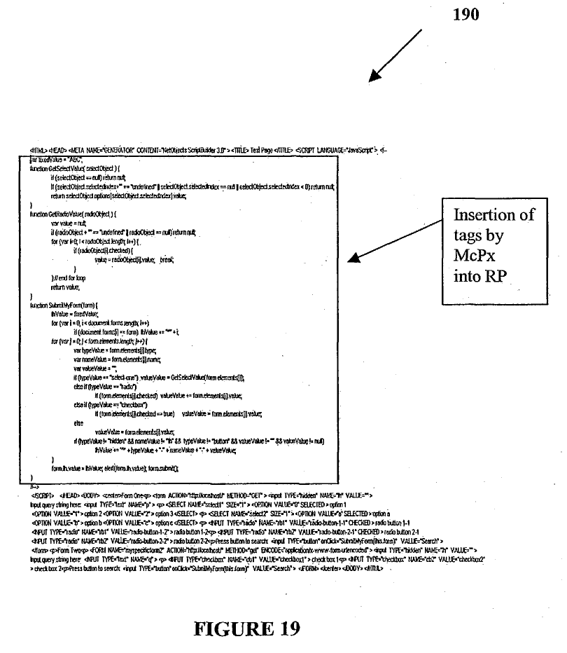

Examples of a portion of a Remote Page and a portion of a Modified Web Page are shown in FIGS. 18 and 19, respectively. In FIG. 19, an insertion of a tag by the Proxy system in a Remote Page is boxed up for illustration purposes.

Record ECI Generation

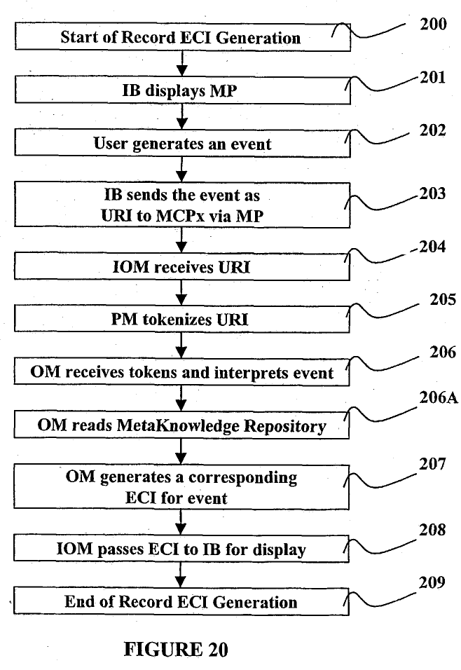

The Record ECI Generation process 155 is described with reference to FIG. 20. Upon receipt of the Modified Web Page delivered by the Proxy system, the Internet Browser displays the Modified Web Page in a step 201. The user then generates an event, for example type a keyword, on the Modified Web Page in a step 202 and the Internet Browser sends the event as a URI to the Proxy system in a step 203. The Proxy system then receives the URI via the I/O Manager 147 in a step 204 and tokenizes the URI via the Parser Manager 145 in a step 205. The tokens are interpreted by the relevant Object Modifier 145D or 145E for determining the type of event performed by the user in a step 206. The relevant Object Modifier 145D or 145E then reads the contents of the MetaKnowledge Repository 136 to determine the relevant responses for the event in a step 206A. A relevant Event Capture Interface is then generated by the respective Object Modifier 145D or 145E in a step 207. The Event Capture Interface is then delivered by the I/O Manager 147 to the Internet Browser in a step 208 for display on the IB computer 131 and thereby for facilitating the acquisition of Process Knowledge.

The Object Modifiers 145D and 145E generate queries via the MetaKnowledge Repository 136 for each object so that Process Knowledge may be properly elicited from the users. The architecture is designed to be scalable such that the users may add new Object Modifiers or extend the existing Object Modifiers and the MetaKnowledge Repository 136 for new and/or changes in domain specific knowledge acquisition purposes.

Record Knowledge Acquisition

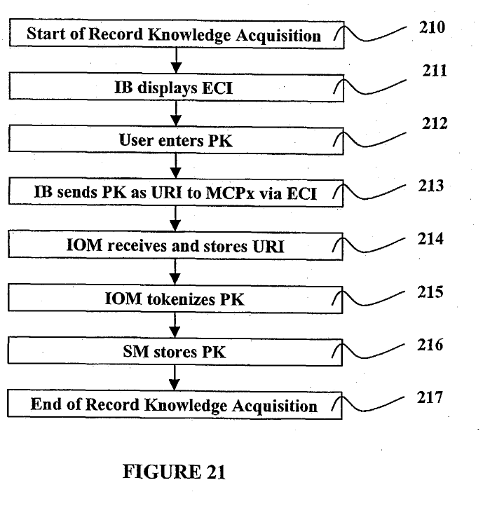

The Record Knowledge Acquisition process 156 is described with reference to FIG. 21. This process starts off with the Internet Browser displaying the Event Capture Interface delivered by the I/O Manager 147 in a step 211. The user then inputs Process Knowledge via the Event Capture Interface displayed on the Internet Browser in a step 212. The Internet Browser then sends the acquired Process Knowledge as a URI to the Proxy system in a step 213. The Proxy system then receives and stores the URI in a step 214 and tokenizes the URI in a step 215 via the I/O Manager 147. The relevant URI is stored for submission by the Proxy system for retrieving information from a next Remote Site, if this differs from the Remote Site 133.

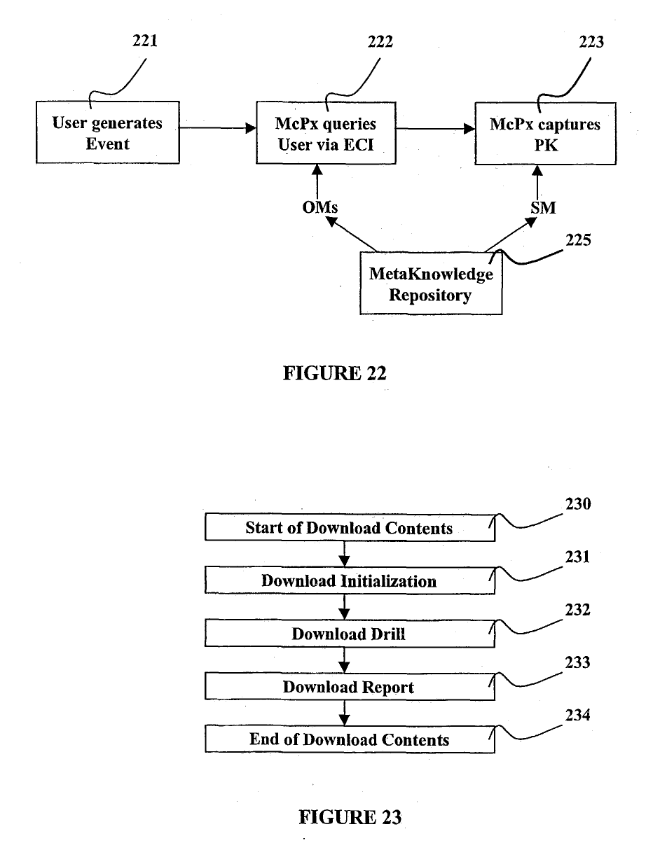

The role performed by the MetaKnowledge Repository 136 in the knowledge acquisition and Process Knowledge harvesting processes is described with reference to FIG. 22. The Script Module 143B processes the extracted URI tokens and stores Process Knowledge as part of the script that the user through the automating system generates (221). Just like the Object Modifiers 145D and 145E (222), the Script Module 143B also makes use of the MetaKnowledge Repository 136 to determine how Process Knowledge may be captured. This is achieved by checking the tags of the tokens (223) against the information stored in the MetaKnowledge Repository 136 (224).

The MetaKnowledge Repository 136 preferably provides or holds instructions and explanations about the queries that are to be displayed to the user, domain specific information for reminding the user about certain events, and lists of hyperlinks for the user to explore before a value is entered or an option is set.

The MetaKnowledge Repository 136 also preferably provides or holds links or queries to search data sources so that the user may easily populate values into objects, and notices and/or advertisements that organizations may place at relevant objects so as to facilitate the pushing of information to the user.

Download Contents

The Download Contents process 157 includes the following sub-processes: “Download Initialization”; “Download Drill”; and “Download Report”, as shown in FIG. 23.

In the Download Initialization sub-process 231, the Internet Browser sends a “start download” instruction to the Proxy system so that a “Page Collection Interface” (PCI) may be generated to determine how the user may wish to download contents or Internet information. A Page Collection Interface refers to any one of the foregoing page collection GUIs 60, 70, or 80.

In the next Download Drill sub-process 232, the Proxy system receives and collects Remote Pages related by hyperlinks found on the latest Remote Page received according to the download parameters sent by the user using a Page Collection Interface. In the further Download Report sub-process 233, the user is informed of the status of downloading.

Download Initialization

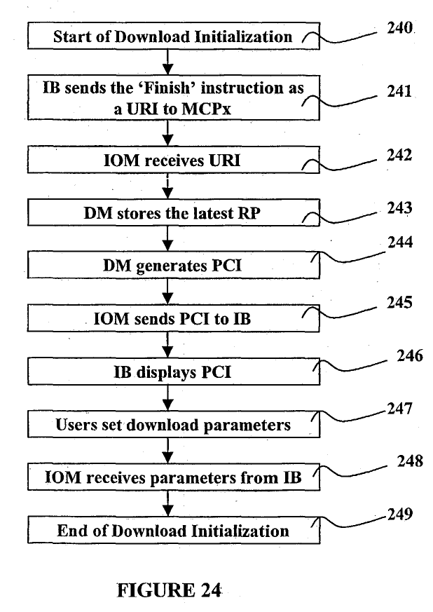

In the Download Intiatialization sub-process 231 shown in FIG. 24, a download instruction is sent as a URI by the Internet Browser to the Proxy system when the user clicks the Finish button 15 on the toolbar 10 in a step 241. The Download Manager 144 next in a step 242 receives the URI via the I/O Manager 147 and proceeds to store the Remote Page in the output directory (specified using playback GUI 110) in a step 243. At the same time, the Download Manager 144 also generates a Page Collection Interface for querying the user on how the user intends to collect Internet information using the latest Remote Page obtained in a step 244 and via the I/O Manager 147 sends the Page Collection Interface to the Internet Browser in a step 245. The Internet Browser then displays the Page Collection Interface in a step 246 so that the user may set the download parameters in a step 247. This information is then sent back to and received by the I/O Manager 147 in a step 248 for further processing by the Download Manager 144.

Download Drill

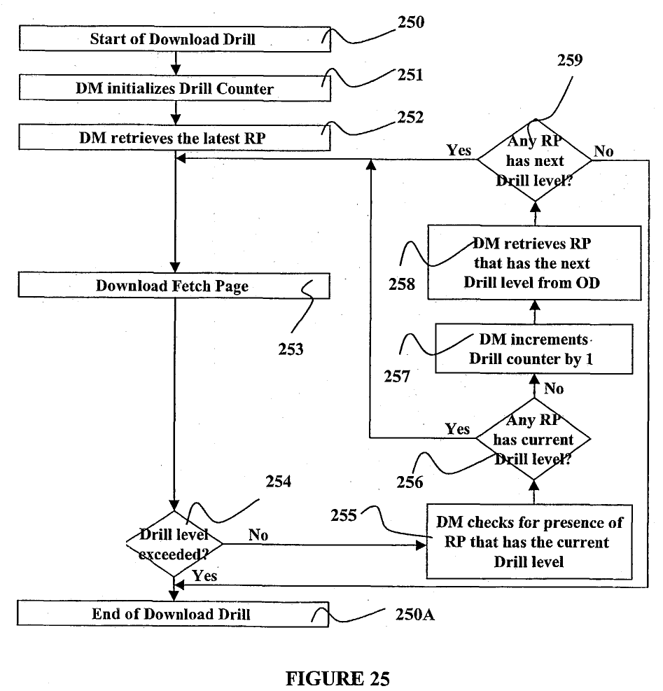

The Download Drill sub-process 232 is described with reference to FIG. 25. The Download Manager 144 in a step 251 initializes a “Drill Counter” and retrieves the latest Remote Page generated in a step 252. A “Download Fetch Page” sub-sub-process 253 is executed for fetching objects from the Remote Web Site. The Download Manager 144 then checks if the drill level has exceeded that specified by the user, via the Page Collection Interface, in a “Breadth First Fetching” manner, i.e., horizontal drilling first followed by vertical drilling, in a step 254.

If the drill level is not exceeded, the Download Manager 144 retrieves a Remote Page from the output directory in a step 255 and checks if this Remote Page is of the same drill level in a step 256. If this Remote Page is of the same drill level, the Download Fetch Page sub-sub-process 253 is performed for this Remote Page. If the Download Manager 144 is unable to find any Remote Page of the same drill level, the Drill Counter is incremented by 1 in a step 257 and the Download Manager 144 attempts to retrieve a Remote Page that meets the incremented drill level in steps 258 and 259. The Download Fetch Page sub-sub-process is performed for the Remote Page that is found. If the Download Manager is unable to find any Remote Page that meets the incremented drill level, the Download Drill sub-process 232 is terminated.

Download Fetch Page

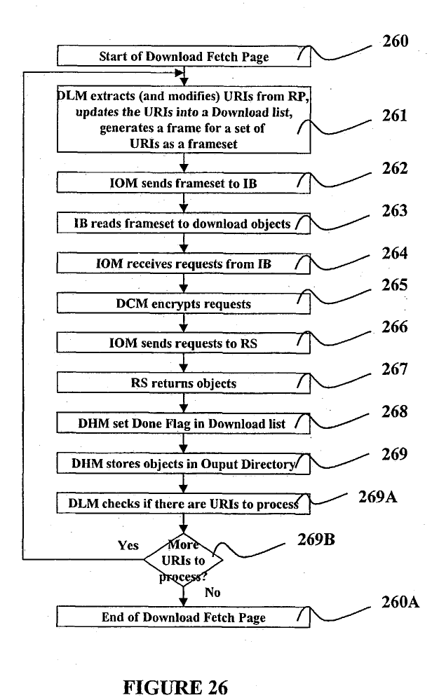

The Download Fetch Page sub-sub-process 253 is described with reference to FIG. 26. In a step 261, the Download Manager 144 extracts and modifies URIs from the Remote Page, and stores these URIs in a “Download List” within the Download Manager 144. A set of Modified Pages or a frameset for a set of URIs are generated and sent to the Internet Browser. It may not be feasible for a frameset to be generated for all URIs as a Remote Page may contain too many URIs to be readily viewed in one screen. The frameset is also used for informing the user about the status of the downloading process.

At the same time, I/O Manager 147 sends the frameset to the Internet Browser in a step 262, which the Internet Browser reads in a step 263. The Internet Browser next in a step 264 submits requests for harvesting of more Remote Pages and other objects from the Remote Web Site. The Decryption Manager 146 encrypts these requests in a step 265 and the I/O Manager 147 next sends these request to the Remote Web Site in a step 266.

The Remote Web Site in a step 267 returns the objects. The Download Handler Manager 147C in the I/O Manager 147 sets a ‘Done flag’ in Download list in a step 268 and proceeds to store the objects in the Output Directory in a next step 269. The Download List Module 144A in the Download Manager 144 then checks in a step 269A if there is a need to generate more framesets for any URIs that await processing. In a step 269B, if it is determined that there is no need to generate more framesets, the Download Fetch Page further sub-process 253 is terminated. Otherwise, the Download Fetch Page further sub-process 253 continues to process the other framesets in step 261.

Download Report

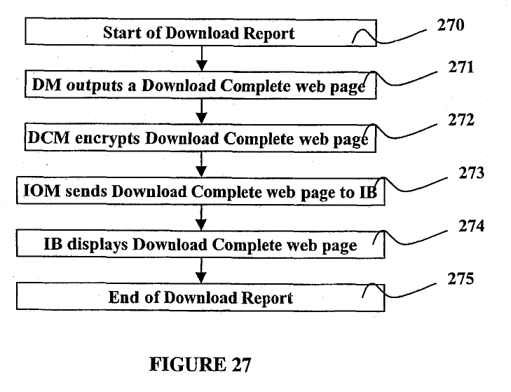

The Download Report sub-process 233 is described with reference to FIG. 27. The Download Manager 144 first generates a “Download Complete Web page” for notifying the user that the downloading process is done in a step 271. The Web page is encrypted in a step 272 and sent to the Internet Browser via the I/O Manager 147 in a step 273 for display on the Internet Browser in a step 274.

PlayBack Session

The automating system preferably allows two ways for the user to start the Playback Session, and this is shown in FIG. 28. The user may either choose to execute a script by feeding the script directly to the MC system via processes 281 and 286, or execute the MC system first and then choose a script to play on the MC system via processes 281 to 285. The latter approach allows the user, when the MC system prompts for the location of the scrip in a process 282, to select the script in a process 283, and to modify keywords of a script in a process 284 before playing the script and to apply the changes in a process 285. The Playback session also includes the following processes: a “Playback Initialization” process 287 for invoking and initializing the Internet Browser and the Proxy system; a “Playback RP Collection” process 288 for collecting the contents of Remote Pages from a Remote Site; and a “Playback Download Contents” process 289, which is carried out in the same way as the Download Contents process 157.

Playback Initialization

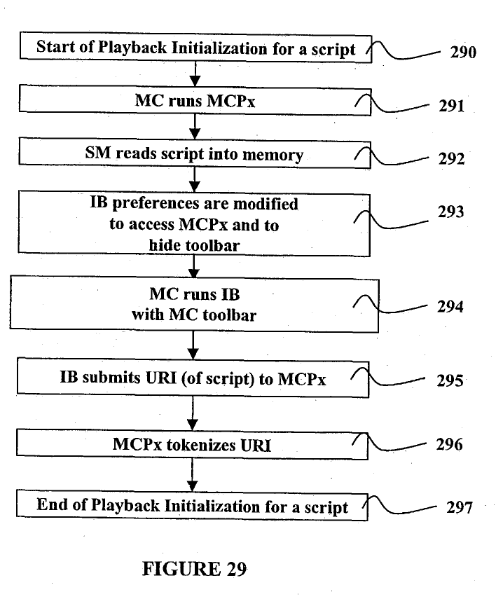

The Playback Initialization process 287 is described with reference to FIG. 29. In a step 291, the MC system starts up the Proxy system which leads to a step 292 where the Script Module 143B reads the script chosen by user. The MC system then in a step 293 modifies the Internet Browser preference setting to access the Proxy system, hiding the Internet Browser's toolbar, and displays the toolbar 10 in a next step 294. The Internet Browser next in a step 295 submits to the Proxy system a request for a “home” or front page which belongs to the Proxy system by submitting a URI specified in the script. The Proxy system retrieves and tokenizes the URI in a step 296 and sends the Proxy system home page to the Internet Browser for display.

Playback RP Collection

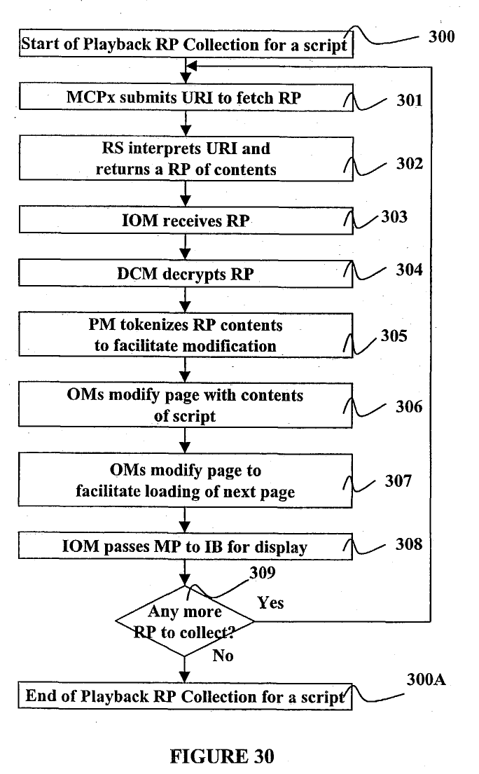

The Playback RP Collection process 288 process is described with reference to FIG. 30. The Proxy system first submits the URI to the relevant Remote Site for fetching the Remote Page in a step 301. The Remote Site next in a step 302 interprets the URI and returns the requested Remote Page. The Remote Page is received by the I/O Manager 147 in a step 303 and the Decryption Manager 146 decrypts the Remote Page in a step 304. The Parser Manager 145 in a step 305 directs the Remote Page to the relevant parser 145A to 145C, where the Remote Page is parsed and tokenized into elements. The Parser Manager 145 then in a step 306 calls the relevant Object Modifier 145D or 145E to perform the modification of these elements. Since the script has recorded therein what the user has perviously done at this stage of the activity, the relevant Object Modifier 145D or 145E modifies the parsed elements to the desired state, for example adding JavaScript or HTML meta tags, thereby forcing the Internet Browser when reading the Remote Page (in a step 308) to automatically perform the events or actions intended by the relevant Object Modifier 145D or 145E. After the relevant Object Modifier 145D or 145E has completed the modification, the elements are returned to the relevant parser 145A to 145C to reverse parse or back-parse the elements in order to “glue” the modified elements for forming a complete and modified Remote Page in a step 307. The resultant Modified Page is then delivered via the I/O Manager 147 to the Internet Browser for display in the step 308. The steps repeat until there are no more URIs for the Proxy system to process (309).

Script Maintenance Session

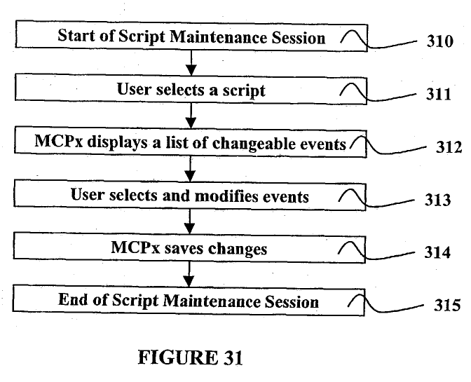

The automating system also provides a facility for the user to perform script maintenance via a “Script Maintenance” process shown in FIG. 31. The user first selects a script in a step 311. A list of events which have modifiable values are displayed by the. Proxy system for the user to browse and change in a step 312. After the user selects the script and makes the changes in a step 313, the changes are then saved in a step 314.

MultiScript Session

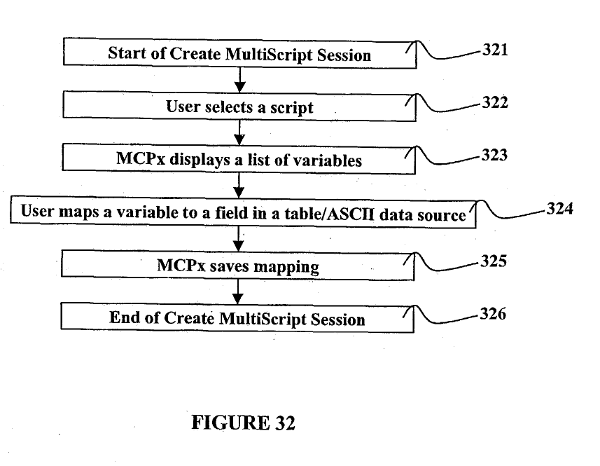

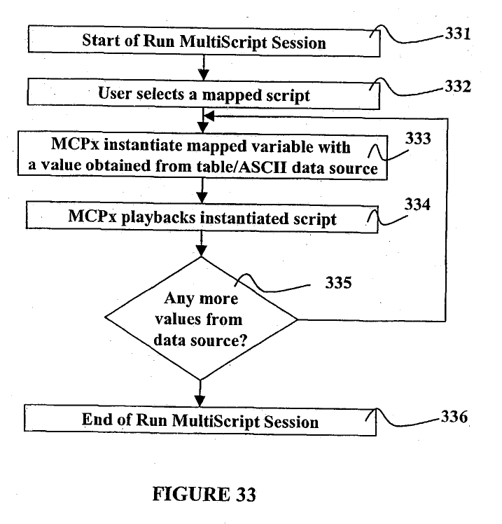

The automating system further provides facilities for the user to create and run a MultiScript Session shown in FIGS. 32 and 33 respectively. This allows the automating system to interface variables in a script with data sources such as a “Legacy Data Source” 136 shown in FIG. 13 for the automating system to repetitively execute the scripts with a range of values for each variable.

In a “Create MultiScript” process shown in FIG. 32, the user first starts the process by clicking on a “MultiMap” button 18 on the toolbar 10 in a step 321. The user then selects a script in a step 322. The Proxy system next displays a list of variables form in the script in a step 323. The user then maps a variable in the list to a field in a table or ASCIII data file residing in the Legacy Data Source 138 in a step 324. In a next step 325, the Proxy system saves the results of the mapping process.

In a “Run MultiScript” process shown in FIG. 33, the user first starts the process by clicking on a ‘MultiPlayback” button 19 on the toolbar 10 in a step 331. The user then selects a mapped script in a step 332. The Proxy system next instantiates the mapped variables in the selected script with a value obtained from the table or ASCII data file in a step 333. The Proxy system next performs a playback of the instantiated script in a step 334. Thereafter, the Proxy system in a step 335 checks if there are any more values from the table or ASCII data file for further instantiation of the mapped variables. If there are more values for instantiation, the process loops back to step 333; otherwise, the process terminates.

Implementation Using Computers

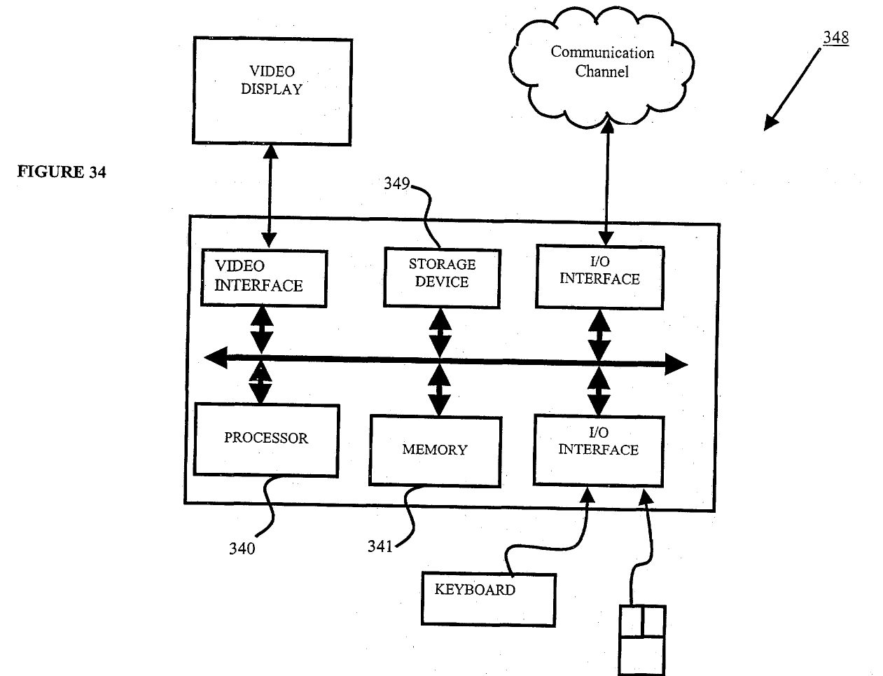

The embodiments of the invention may be implemented using a computer or a network of computers, where any computer may be a general-purpose computer being shown in FIG. 34. In particular, the functionality or processing by the automating system described with reference to FIGS. 1 to 33 may be implemented as software, or a computer program, executing on the computer(s). The automating system is effected by instructions in the software that are carried out by the computer(s). The software may be implemented as one or more modules for implementing processes or steps therein. A module is a part of a computer program that usually performs a particular function or related functions. Also, as described in the foregoing, a module can also be a packaged functional hardware unit for use with other components or modules.

In particular, the software may be stored in a computer readable medium, including the storage devices described below. The software is preferably loaded into the computer from the computer readable medium and then carried out by the computer. A computer program product includes a computer readable medium having such software or a computer program recorded on it that can be carried out by a computer. The use of the computer program product in the computer preferably effects an advantageous apparatus for automating a web browser application in accordance with the embodiments of the invention.

A computer system 348 is simply provided for illustrative purposes and other configurations can be employed without departing from the scope and spirit of the invention. Computers with which the embodiment can be practiced include IBM-PC/ATs or compatibles, one of the Macintosh (TM) family of PCs, Sun Sparcstation (TM), a workstation or the like. The foregoing is merely exemplary of the types of computers with which the embodiments of the invention may be practiced. Typically, the processes of the embodiments, described hereinafter, are resident as software or a program recorded on a hard disk drive (generally depicted as block 349 in FIG. 34) as the computer readable medium, and read and controlled using the processor 340. Intermediate storage of the program and any data may be accomplished using the semiconductor memory 341, possibly in concert with the hard disk drive 349.

In some instances, the program may be supplied to the user encoded on a CD-ROM or a floppy disk (both generally depicted by block 349), or alternatively could be read by the user from the network via a modem device connected to the computer, for example. Still further, the software can also be loaded into the computer system 348 from other computer readable medium including magnetic tape, a ROM or integrated circuit, a magneto-optical disk, a radio or infra-red transmission channel between the computer and another device, a computer readable card such as a PCMCIA card, and the Internet and Intranets including email transmissions and information recorded on websites and the like. The foregoing is merely exemplary of relevant computer readable mediums. Other computer readable mediums may be practiced without departing from the scope and spirit of the invention.

In the foregoing manner, a system for automating browsers through which browser-based activities are performable on Web pages or the like Internet information accessible via the Internet or the like network, is disclosed. A number of embodiments are described. However, it will be apparent to one skilled in the art in view of this disclosure that numerous changes and/or modification can be made without departing from the scope and spirit of the invention.

1. A method for automating events performable on information requested by a user using a browser, said method including the steps of:
receiving 'said requested information for viewing on said browser;
modifying said requested information, including tagging data therein upon which an event is dependable;
monitoring occurrence of said event using said tagged data; and
performing knowledge acquisition when said event is performed by said user, wherein knowledge being acquired relates to logic by which said user performs said event.

2. The method as in claim 1, wherein said step of performing knowledge acquisition includes the step of interacting with said user in relation to said knowledge acquisition.

3. The method as in claim 2, wherein said step of interacting with said user includes the step of generating knowledge acquisition prompts.

4. The method as in claim 3, wherein said step of generating knowledge acquisition prompts include the step of storing said knowledge acquisition prompts in a knowledge acquisition repository.

5. The method as in claim 1, further including the step of generating a script for recording occurrence of said event and said logic.

6. The method as in claim 5, wherein said step of generating said script includes the step of storing said script in a script repository.

7. The method as in claim 5, wherein said step of generating said script includes the step of generating a script having a variable dependable upon a value from a range of values.

8. The method as in claim 7, further including the step of storing said range of values in a data source from which said value is extractable.

9. The method as in claim 5, further including the step of executing said script leading to re-occurrence of said event.

10. The method as in claim 1, further including the step of downloading further information dependent on occurrence of said event.

11. The method as in claim 10, wherein said step of downloading further information includes the step of drilling for further information.

12. The method as in claim 11, wherein said step of drilling for further information includes the step of vertically drilling for further information.

13. The method as in claim 10, wherein said step of downloading further information further includes the step of storing said further information in an information repository.

14. A system for automating events performable on information requested by a user using a browser, said system including:
means for receiving said requested information for viewing on said browser;
means for modifying said requested information, including means for tagging data therein upon which an event is dependable;
means for monitoring occurrence of said event using said tagged data; and
means for performing knowledge acquisition when said event is performed by said user, wherein knowledge being acquired relates to logic by which said user performs said event.

15. The system as in claim 14, wherein said means for performing knowledge acquisition includes means for interacting with said user in relation to said knowledge acquisition.

16. The system as in claim 15, wherein said means for interacting with said user includes means for generating knowledge acquisition prompts.

17. The system as in claim 16, wherein said means for generating knowledge acquisition prompts include means for storing said knowledge acquisition prompts in a knowledge acquisition repository.

18. The system as in claim 14, further including means for generating a script for recording occurrence of said event and said logic.

19. The system as in claim 18, wherein said means for generating said script includes means for storing said script in a script repository.

20. The system as in claim 18, wherein said means for generating said script includes means for generating a script having a variable dependable upon a value from a range of values.

21. The system as in claim 20, further including means for storing said range of values in a data source from which said value is extractable.

22. The system as in claim 18, further including means for executing said script leading to re-occurrence of said event.

23. The system as in claim 14, further including means for downloading further information dependent on occurrence of said event.

24. The system as in claim 23, wherein said means for downloading further information includes means for drilling for further information.

25. The system as in claim 24, wherein said means for drilling for further information includes means for vertically drilling for further information.

26. The system as in claim 23, wherein said means for downloading further information further includes means for storing said further information in an information repository.

27. A computer program product, including a computer usable medium having computer readable program code means embodied in said medium for automating events performable on information requested by a user using a browser, said computer program product having:
computer readable program code means for receiving said requested information for viewing on said browser;
computer readable program code means for modifying said requested information, including tagging data therein upon which an event is dependable;
computer readable program code means for monitoring occurrence of said event using said tagged data; and
computer readable program code means for performing knowledge acquisition when said event is performed by said user, wherein knowledge being acquired relates to logic by which said user performs said event.

28 The product as in claim 27, wherein said computer readable program code means for performing knowledge acquisition includes computer readable program code means for interacting with said user in relation to said knowledge acquisition.

29. The product as in claim 28, wherein said computer readable program code means for interacting with said user includes computer readable program code means for generating knowledge acquisition prompts.

30. The product as in claim 29, wherein said computer readable program code means for generating knowledge acquisition prompts include computer readable program code means for storing said knowledge acquisition prompts in a knowledge acquisition repository.

31. The product as in claim 27, further including computer readable program code means for generating a script for recording occurrence of said event and said logic.

32. The product as in claim 31, wherein said computer readable program code means for generating said script includes computer readable program code means for storing said script in a script repository.

33. The product as in claim 31, wherein said computer readable program code means for generating said script includes computer readable program code means for generating a script having a variable dependable upon a value from a range of values.

34. The product as in claim 33, further including computer readable program code means for storing said range of values in a data source from which said value is extractable.

35. The product as in claim 31, further including computer readable program code means for executing said script leading to re-occurrence of said event.

36. The product as in claim 27, further including computer readable program code means for downloading further information dependent on occurrence of said event.

37. The product as in claim 36, wherein said computer readable program code means for downloading further information includes computer readable program code means for drilling for further information.

38. The product as in claim 37, wherein said computer readable program code means for drilling for further information includes computer readable program code means for vertically drilling for further information.

39. The product as in claim 36, wherein said computer readable program code means for downloading further information further includes computer readable program code means for storing said further information in an information repository.
